(19) United States
(12) Patent Application Publication
(10) Pub. No.: US 2002/0083318 A1
(43) Pub. Date: Jun. 27, 2002

(54) Method and system for software integrity control using secure hardware assist

(76) Inventor: Gordon Edward Larose, Ottawa (CA)

Correspondence Address: SMART & BIGGAR, P.O. BOX 2999, STATION D, 55 METCALFE STREET, SUITE 900, OTTAWA, ON, K1P5Y6, CA

(21) Appl. No.: 09/745,505

(22) Filed: Dec. 26, 2000

(51) Int. Cl. H04L 9/00

(52) U.S. Cl. 713/164

(57) ABSTRACT

The present invention relates to a method and system for using a secure hardware adjunct in an otherwise open personal computer or other computing appliance. The secure hardware adjunct contains a microprocessor, or equivalent, and can perform cryptographic functions, notably encryption/decryption and secure storage of cryptographic keys. The secure hardware adjunct is used to integrate a non-executable form of a software application with selected “sensitive functions” so as to produce an executable instance of the program incorporating these functions. The sensitive functions could be of any nature, but a typical application would be functions to enforce Digital Rights Management (DRM) rules on the execution of the software. Optionally, environmental data may also be integrated with the non-executable form of the software application.

### FIELD OF THE INVENTION

The present invention relates to the use of trusted security hardware in the prevention of unauthorized use of computer software.

### BACKGROUND OF THE INVENTION

Since the beginning of the personal computing era in the late 1970s, publishers of computer software programs have been concerned with software piracy. One problem that exists is ensuring that users comply with the terms of the software program licenses and purchase enough licenses to cover the number of computers onto which the software program is installed or on which the software program is active at a given time. Most software programs can be easily copied and used on multiple personal computers without the publisher receiving compensation for this additional use. In the last few years, computer software protection has grown in importance as novel distribution and sales mechanisms are increasingly being used by software publishers and distributors to deliver computer software to users. These include “try before you buy”, time limited software demonstrations, software rentals and software metering.

The problem is that it is very difficult to include any kind of run-time control in a computer software program which is not trivially removable by a person technically skilled in the art. This is due to the open architecture of the personal computer, in which several processes can run concurrently, with each having access to the contents of random access memory (RAM) and the hard drive a personal computer. If a program contains software code that attempts to provide run-time control, such as user authentication, its actions can be examined and recorded by a concurrently running application, such as a software debugger, and the control mechanisms can be reverse-engineered. Once the mechanisms are understood, the code can be modified in such a way that these mechanisms are disabled but the rest of the software functionality remains intact. An attacker can then go on to automate the code modification process in the form of a “crack”, which can be used even by the technically unsophisticated to use the software free of any controls.

A technique commonly used to deter pirates is to distribute a computer software program in encrypted form. However, the distribution of a computer software program in encrypted form, where such computer software program is decrypted before use, does not necessarily yield a sufficient degree of protection from hackers. Even if a secure hardware device performs the decryption of the encrypted computer software program, a hacker can capture the decrypted program in memory or on disk, and store it for later unauthorized use and/or redistribution. This is because, absent other measures, all instances of the computer program are in an identical uncontrolled form once decrypted and are thereby susceptible to hacking.

One way of increasing the resistance of a computer software program to hacker attacks is by adding a secure, tamper-resistant hardware-based adjunct device, or “black box” to a personal computer. An example of this is the “dongle,” a piece of hardware that attaches to a personal computer via one of its external ports, and which is required in order for the program to run. The use of a dongle has been incorporated into a limited number of software applications. However, a hacker can still produce a re-distributable crack by using a software debugger to examine the workings of the application and modifying the code so as to remove the dependency on the dongle.

A more sophisticated instance of such a “black box” is a smart card and associated reader attached to a personal computer. In a typical application, a user would insert a smart card containing a processor and cryptographic keys into a smart card reader, and a remote server would be used by the personal computer to provide authentication services, thereby providing a Virtual Private Network. However, in this case, the personal computer is an un-trusted intermediary in a chain of authentication. A hacker cannot generally defeat this type of system by attacking the computer software code, because the cryptographic keys or any other authenticable data are not available in, or used by, the locally executing code. Indeed, in this instance there is nothing sensitive in the locally executing code and this smart card system does not fully leverage the security capabilities of such a trusted hardware device for increasing the security of locally executing code.

While there exist numerous systems and methods that aim to control unauthorized copying and access to computer software programs (both with and without a trusted hardware device such as a smart card), a need exists for a system and method that enforces sensitive functions such as digital rights management in a manner that is highly resistant to software piracy.

### SUMMARY OF THE INVENTION

The present invention relates to a method and system that enforces digital rights management by integrating, at the digital appliance (e.g. personal computer) level, desired security functions into an underlying computer software application resulting in a locally executable instance of the computer software application incorporating the desired added security functions. Through the use of a trusted secure hardware adjunct in the integration process, the executable instance of the computer software application can be highly customized and therefore resistant to the production of redistributable “cracks”.

The present invention utilizes a secure, tamper-resistant hardware-based adjunct device in an open-architecture digital appliance, such as a personal computer, in order to increase the level of security of a locally executing software application. A “neutral form” of the application (i.e. non-executable), typically encrypted in such a way as to be readable only by the secure hardware adjunct, is first distributed to a user by any convenient electronic or physical means. In addition, one or more sets of associated “sensitive functions” such as digital rights management enforcement instructions, which are desired to be functionally added to the software application, are distributed to the same computer by the same or different means. Finally, there is “integration framework” software that executes in the processor of the digital appliance, and also inside the secure hardware adjunct. Under the control of the integration framework software, the hardware-based adjunct device uses environmental and other data to perform an untamperable integration process, which uses as input the application neutral form and the sensitive functions. The output is an executable instance of the application that incorporates the sensitive functions or a subset thereof.

The executable instance of the software application can be unique and dependent on any one or more of a number of variables to execute, including the presence of a specific digital appliance and/or secure hardware adjunct. The executable instance of the software application can also be made resistant to the production of redistributable “cracks” designed to remove the effect of the sensitive functions, because it can be different at the binary level from all other executable instances of the program.

In accordance with an aspect of the present invention there is provided a method of producing an executable instance of a software application in a secure hardware adjunct where secure processing is performed. The method comprises the steps of: providing a non-executable form of a software application and sensitive functions to the secure hardware adjunct; transforming the non-executable form of the software application into an executable form in the secure hardware adjunct; integrating the sensitive functions with the executable form of the software application in the secure hardware adjunct to produce an executable instance of the software application; and outputting an executable instance of the software application to a digital appliance such as a personal computer.

Other aspects and features of the present invention will become apparent to those of ordinary skill in the art, upon review of the following description of specific embodiments of the invention in conjunction with the accompanying figures.

### BRIEF DESCRIPTION OF THE DRAWINGS

In figures which illustrate, by way of example only, embodiments of the present invention,

FIG. 1 is a schematic diagram of a general form of the components of the present invention;

FIG. 2 is a simplified flowchart of the transformation and integration steps of the present invention;

FIG. 3 is a more detailed flowchart of the transformation and integration steps illustrated in FIG. 2;

FIG. 4 is a schematic diagram of an embodiment of the present invention using a smart card;

FIG. 5 is a flowchart for the embodiment shown in FIG. 4;

FIG. 6 is a flowchart of the run-time environment of the embodiment shown in FIG. 4;

FIG. 7 is a schematic diagram of an embodiment of the present invention using a secure integrated circuit on a personal computer motherboard; and

FIG. 8 is a flowchart for the embodiment shown in FIG. 7.

### DETAILED DESCRIPTION OF THE PREFERRED EMBODIMENT

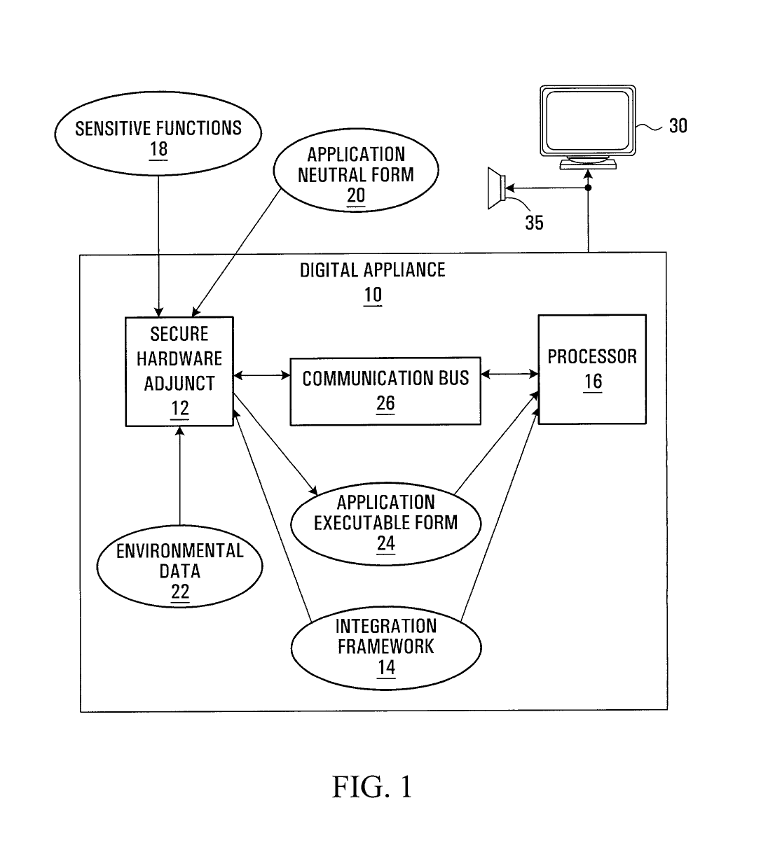

FIG. 1 is a schematic diagram of a general form of the basic components of the present invention. A digital appliance 10 is shown, which can be a personal computer, computer server, handheld computer, or other appliance. Digital appliance 10 includes a processor 16 and a communications bus 26. Processor 16 runs the integration framework software 14 that oversees the integration process described herein which results in the outputting of a locally executable version of a computer software application (referred to herein as the application executable form 24). Digital appliance 10 typically includes some form of output device, be it a display monitor 30 and/or a speaker 35.

A secure hardware adjunct 12, which communicates with processor 16 by communications bus 26, performs the transformation operations of the invention, which render the file executable and integrate the sensitive functions. Note that the actual physical connection between the secure hardware adjunct 12 and the processor 16 may involve various kinds of buses 26 and intermediary links, including for example wireless connections to non-contact smart cards.

The secure hardware adjunct 12 may be one of various kinds of hardware device e.g. a smart card, cryptographic co-processor etc. For the purposes of this invention secure hardware adjunct 12 must include a processor, permanent instruction and data storage (read only memory) and temporary data storage (random access memory), input and output paths for communication with the processor 16 of the digital appliance 10, and some form of packaging that resists tampering and observation of internal data and algorithms. Further hardware capabilities such as built-in random number generators, the ability to receive and execute code from the host digital appliance, a high-performance microprocessor, or a high-bandwidth connection to the processor of the digital appliance, may be utilized by this invention for improved performance if present, but are not necessary.

From a functional perspective, the secure hardware adjunct 12 must be capable of storing secret data such as cryptographic keys and executing hidden software algorithms, and of performing cryptographic and other operations in a fashion at least partially controllable by the digital appliance 10. The secure hardware adjunct 12 can be implemented and distributed in a number of ways. These include, i. a secure integrated circuit on the motherboard of the digital appliance 10; ii. a secure integrated circuit on an expansion board of the digital appliance 10; iii. an external device that is connected to the digital appliance 10 through an external port, such as a serial port or a USB port; iv. a component of a specialized digital appliance, such as a wireless Internet-enabled handheld device; or v. a smart card and smart card reader.

The secure hardware adjunct 12 can contain a unique serial number that can be used to bind an executable computer software program created with such adjunct to digital appliance 10. As well, secure hardware adjunct 12 can have the capability to scan digital appliance 10 and record relevant environmental hardware parameters such as serial numbers from various hardware components such as the motherboard, and the unique MAC address from a network interface card, if one is present. Operating system data such as version number and serial number can also be recorded by the secure hardware adjunct 12 and incorporated into the application executable form 24. When the application executable form 24 is run, it can compare the recorded data to the current machine environment to ensure that it is not being run on a different digital appliance.

The secure hardware adjunct 12 may also have the capability to retrieve data from an Internet server that will be bound to the application executable form 24. For example, this data could be a unique serial number for each use of the product and would allow per-use tracking. Such capability does not require any direct connections from the secure hardware adjunct 12 to the Internet server. As described earlier in the context of a Virtual Private Network application of smart cards, the cryptographic capabilities of the secure hardware adjunct 12 enable it to have a secure interaction with an Internet server even if the communication path goes through, for example, processor 16 of digital appliance 10. The secure hardware adjunct 12 could also request user input to be incorporated into the application executable form 24, such as a user name and password, to ensure that the user had the right to use the program.

The secure hardware adjunct 12 may also contain additional functionality utilizable by the processes described below. For example, if the secure hardware adjunct 12 were a multifunction smart card which included a reserve of electronic cash, then that capability could be utilized, via initiating an interaction with an appropriate banking server, to collect payment for use of a computer software application.

Application neutral form 20 is a derivative form of an underlying computer software application (i.e. the unrestricted retail form). The application neutral form 20 is freely distributable since it will not run and deliver its original functionality until transformed according to the method and system of the present invention. Further it will typically be (at least partially) strongly encrypted in such a way that only the secure hardware adjunct 12 can decrypt it via the use of asymmetric encryption algorithms and hidden keys. In this way it is an opaque object which never appears “in the clear” and is not subject to useful inspection such as disassembly by computer hackers. Where the application neutral form 20 is delivered to a user electronically, the application neutral form could be uniquely encrypted on the fly at the server as part of the delivery, such that each user would require a unique decryption key in order to access the application. The application neutral form 20 is independent of any specific secure hardware adjunct 12.

From the user's point of view, the fact that the application neutral form 20 is unusable for the original purposes of the underlying software program need not be apparent. For example, the conversion process employed by a computer software publisher could produce an application neutral form 20 which will initially run just like the original program, but which will then transfer control to the integration framework software 14. There are a number of methods known in the art for this, such as modifying the structure of a Windows executable file by injecting additional dynamically linked library (DLL) dependencies into the application neutral form 20.

Integration framework software 14 is used to control the transformation of a computer software program from application neutral form 20 into application executable form 24. Integration framework software 14 has a component that is executed in processor 16, and a component that is executed by the processor inside the secure hardware adjunct 12. This latter component takes the form of binary software code that could be built-in to the secure hardware adjunct 12, or could be uploaded as needed. It is important to note that the integration framework software 14 is not hard-coded for particular hardware devices. Instead, it is metadata driven and can detect and accommodate different types of secure hardware adjuncts. It may, through network interaction, obtain additional logic to accommodate device types that were not defined when it was originally distributed.

The integration framework software 14 is capable of inspecting the environment and adapting the system operation to any of a number of secure hardware adjuncts 12. If the integration framework software 14 is network-aware, support can be expanded to address any secure hardware adjunct 12, even after the application neutral form 20 is distributed. The integration framework software 14 can follow the evolution of secure hardware adjuncts 12 and provide a level of security that tracks the best available of these devices.

Sensitive functions 18 (or a subset thereof), such as digital rights management algorithms, are integrated with the application neutral form 20 by the secure hardware adjunct 12. Sensitive functions 18 typically perform functions associated with digital rights management that are usually not specific to any given application package. Examples include algorithms designed to ensure that the computer software application cannot be executed on a machine other than a particular digital appliance 10, with or without secure hardware adjunct 12. However, the scope of sensitive functions 18 is not limited to digital rights management application. Other examples of sensitive functions 18 include interacting with an Internet server in order to authenticate a user; scanning a user's digital appliance to determine if the user has established a contract with the application publisher; requesting and downloading cryptographic keys from an Internet server; and scanning a digital appliance for identifying serial numbers or other appliance-specific identifiers.

The sensitive functions 18 will typically be stored on standard computer media, such as a hard disk or CD-ROM, and read by the integration framework software 14, possibly assisted by the secure hardware adjunct 12, when the integration framework software 14 is executed. The sensitive functions 18 may be distributed with the application neutral form 20, but typically they will only be loosely coupled with any particular package. They may be encrypted in such a way that they can only be decrypted by an appropriate adjunct device. This would prevent the inspection of such functions by attackers who did not have such an adjunct or (in the case of adjuncts which would upload, decrypt, and run the code in a hidden manner), it could prevent such inspection altogether.

The environmental data 22 may be used by the integration framework software 14 while creating the application executable form 24. The environmental data 22 could be accessed by the secure hardware adjunct 12 and/or the processor 16 of the digital appliance 10 by means of communications bus 26. Environmental data 22 will vary between computer software applications but could include data derived from the current state of the digital appliance 10 such as the date and time, the hardware and software configuration of the digital appliance 10, data entered by the user, and/or available network-accessible resources.

Note that there are different methods for accessing the environmental data, which depend primarily on the capabilities of secure hardware adjunct 12 and the mechanism by which secure hardware adjunct 12 is connected to the digital appliance 10.

In one method, secure hardware adjunct 12 is located directly on a high-speed communication bus 26 shared with the processor 16 and other devices, and is capable of being a “bus master”. As a bus master, secure hardware adjunct 12 can inspect and possibly control hardware accessible over the bus, without involving processor 16 or any software therein. Thereby, the secure hardware adjunct 12 can independently obtain the environmental data it needs, and the component of the integration framework software 14 that runs on processor 16 need not include such logic. This is desirable from a security perspective, since if the logic is not present in processor 16, it cannot be effectively inspected and/or attacked.

In another method where secure hardware adjunct 12 is a more limited device such as a smart card, the secure hardware adjunct 12 is a “slave” which cannot act independently and is not physically connected to the system in a way that allows it to directly inspect the internals of the digital appliance 10. Smart cards typically have simple serial interfaces running at low data rates such as 9600 baud. In this case, the integration framework software 14 must perform the inspection functions and forward the results to the secure hardware adjunct 12. Note that some aspects of the environmental data 22 may already be present in the smart card and thus do not require such discovery. For example, the user might have a serial number or personal digital certificate associated with particular software usage conditions, pre-loaded in the smart card.

Environmental data 22 could also be provided to secure hardware adjunct 12 by an auxiliary external software program designed for that at least that purpose.

Environmental data 22 can be used in accordance with the integration processes of the present invention by mediating the process by which the application executable form 24 is produced. In one example, environmental data 22 could be used to ascertain that the environment of the digital appliance supports the application executable form 24. More generally, environmental data 22 can be used to tailor the uniqueness of the chosen sensitive functions 18 in random or deterministic ways. An application of this would be to sample a real-time clock of digital appliance 10 and use, for example, the “second” time field, to determine which of two specific possible sensitive functions of a particular sort to integrate. A deterministic application would be to inspect the environment of digital appliance 10 to determine whether the transformation and integration steps of the present invention are to be employed each time application executable form 24 is run, or whether such steps are to be performed only once at initial time of installation. If, for example, digital appliance 10 included no hard-disk or similar non-volatile local storage, and one of the sensitive functions 18 to be integrated was designed specifically to protect the application executable form 24 when stored on a disk drive, clearly this particular sensitive function 18 would not be integrated by integration framework software 14.

Environmental data 22 can also be used in accordance with the integration processes of the present invention to bind the application executable form 24 at its run-time, to a particular attribute of the environment. For example, in a digital appliance with a network interface card using a convention 48-bit physical Media Access Control (MAC) address, a sensitive function 18 could be added to check this address at some intervals during each run of the application executable form 24.

The application executable form 24 is created by the secure hardware adjunct 12 and incorporates the desired sensitive functions 18 and optionally, environmental data 22. Each instance of the application executable form 24 produced by the integration processes of this invention can be unique in arbitrary ways that may be deterministic, environment-related, random etc. The variations could be behavior-affecting, such as including some sensitive functions and not others. They could be simply camouflage, e.g. variations in binary instruction positioning that have no effect on function but increase the difficulty of automated binary code replacement, which is the usual technique for redistributing “cracks”. This procedure is described as follows.

The basic operation of a cracking program is to take a rights-controlled binary executable file as input, modify specific address locations within that file, and produce as output a “cracked” version of the executable file. Internally, a cracking program either removes the sensitive functions altogether so that they are not executed, or modifies them so that they do not perform their function but instead return a code that indicates that they determined that they were running in an authorized environment.

In one embodiment of the application executable form 24, sensitive functions 18 will be embedded at different locations in different instances. This foils a cracking program, since a different program would have to be created for each instance of the application executable form 24, and thus the cracking programs could not be distributed and used on all instances of the application executable form 24. To present further obstacles to crackers, the above process or random location variation may also be applied to some portions of code that do not actually implement sensitive functions 18. This provides a wider degree of instance-to-instance variability that serves to further camouflage the sensitive functions 18.

Following the integration process of the present invention, the application executable form 24 may, or may not, itself depend on the presence of the secure hardware adjunct 12 for proper execution. This is unlike prior art systems that employ hardware-based adjunct devices, which bind a computer software application run-time to a particular adjunct device.

In order to create a package of elements for distribution to a user, a computer software publisher or distributor would first have to create the application neutral form 20. This can entail the following steps:

i. rendering an underlying computer software application (i.e. an unprotected retail version) fundamentally unusable in a direct fashion by digital appliance 10. For instance, application neutral form 20 could be encrypted such that only secure hardware adjunct 12 could decrypt it. There are a number of methods known in the art for providing such encryption. For example, an asymmetrical encryption system such as RSA can be used to encrypt the application neutral form 20. In such a case, the secure hardware adjunct 12 would store the private key in tamperproof storage and uses this key to decrypt the application neutral form 20. Note that due to the nature of RSA and other asymmetric encryption algorithms, the private key never has to be transmitted, so a high degree of security can be offered;

ii. the placement of “hooks” in the application neutral form 20 to which sensitive functions 18 can be subsequently attached. For example, a block of code could be offset a certain number of bytes in order to leave room for a subroutine call to a sensitive function 18. The “fill” used to occupy the resulting unused address space could consist of binary values that were not valid instructions for the particular processor 16, or of legal but erroneous instructions (e.g. jumps to invalid addresses.) Either of the above would result in a program crash if the application neutral form 20 were executed directly. In addition to being non-executable, these binary values would be selected so as to be readily detected by the integration framework software 14—that is, to form tags within the application neutral form 20 which could be used to easily locate the “fill” regions. Alternatively, the application neutral form 20 could have added pointer data which could be used to locate the fill regions.

The computer software publisher or distributor would then choose a set of sensitive functions 18 that are to be used to control one or more aspects of use of the application executable form 24 following the integration step of the present invention. As described above, sensitive functions 18 can include digital rights management and/or links to specific commercial offers related to the specific application and/or user. Such functions might, for example, have the effect of offering time-limited free use of the application executable form 24 to users with smart cards, but not to others.

Appropriate integration framework software 14 for the application neutral form 20 and sensitive functions 18 would then be selected. The above three software items would then be delivered to a user by CD-ROM, Internet download or any other means. One of more of these three software items could be delivered to a user separately and at different times. Upon delivery to the user, the integration and transformation steps of the present invention can be performed with the aim of producing an executable instance of the application neutral form 20 incorporating the desired sensitive functions 18 chosen by the integration framework software 14 based on factors including the environmental data 22.

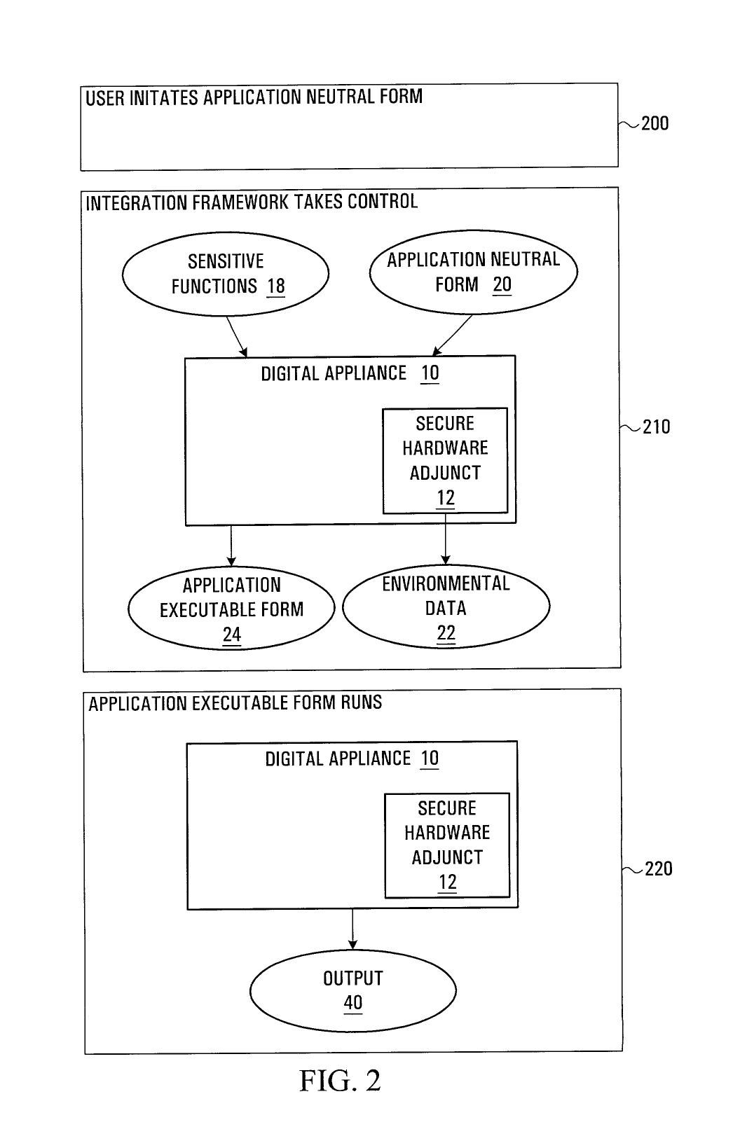

FIG. 2 is a simplified flowchart of the transformation and integration steps of the present invention. At step 200, the user begins execution of the application neutral form 20.

At step 210, the integration framework software 14 is invoked. Under its control, the secure hardware adjunct 12 decrypts the application neutral form 20 and combines it with the sensitive functions 18 to create an application executable form 24. Environmental data 22 would typically, but not necessarily, be involved in the integration process. The end result of the integration process is the application executable form 24 incorporating the desired security functions 18 and (optional) environmental data 22.

At step 220, the application executable form 24 is executed by the user, and runs in accordance with the sensitive functions 18 and optional environmental data 22 that have been bound to it by the integration framework software 14. The user is then presented with output 40 or other interactions as per the functionality of the underlying computer software application.

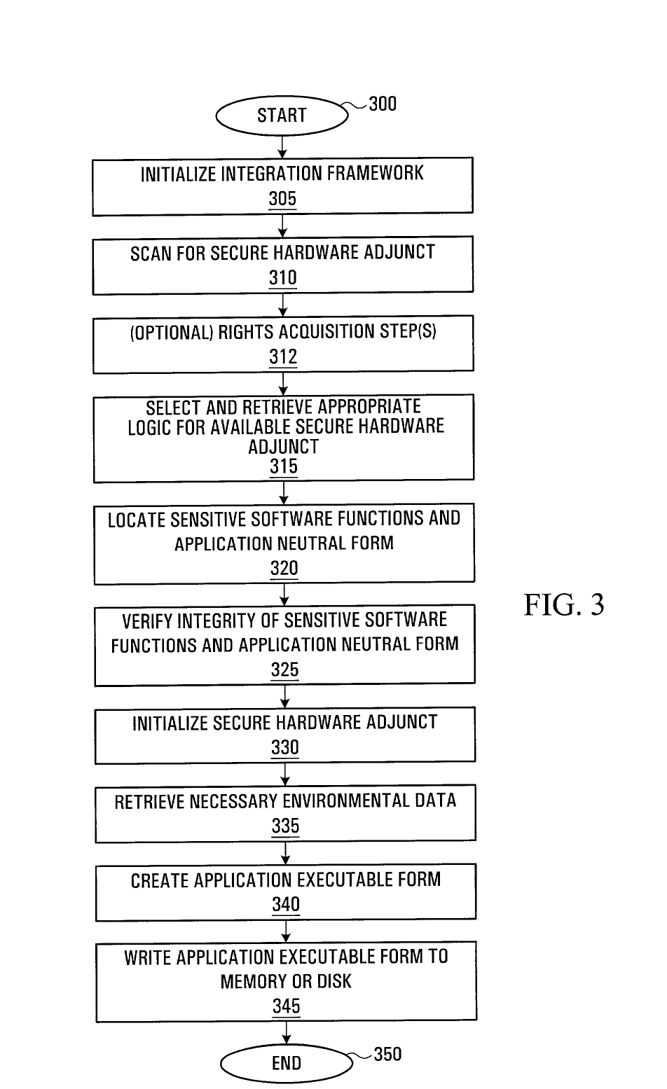

FIG. 3 is a more detailed flowchart of the transformation and integration steps illustrated in FIG. 2. Element numerals refer back to FIG. 1.

At step 300, the user of the digital appliance invokes the application neutral form 20. The application neutral form 20 is not directly executable (at least not to accomplish the functions of the underlying software application) by digital appliance 10. There are many ways in which the application neutral form 20 could be made non-executable. For example, it could be encrypted in such a way that it could only be decrypted through the use of the secure hardware adjunct 12. Alternatively, the application neutral form 20 could be processed with specific “hooks” e.g. non-functional code areas, designed specifically to accommodate the addition of sensitive functions 18 in the following steps. These hooks would not be valid instruction streams. Until they were replaced according to the transformation and integration steps of this invention, the application neutral form 20 would be rendered non-executable.

At step 305, the application neutral form initializes the integration framework software 14. The integration framework software 14 then optionally checks the environment and determines whether digital appliance 10, irrespective of the presence of a secure hardware adjunct 12, presents an environment which supports the particular software program managed according to this invention e.g. whether processor 16 is of a known type of sufficient power to support the application executable form 24. At step 310, the integration framework software 14 scans for secure hardware adjunct 12 to support the integration process of the present invention.

Note that the mere presence of secure hardware adjunct 12 does not necessarily confer any user rights to a particular version of the software application. Rather, integration framework metadata within integration framework software 14 may identify a rights acquisition process that must be executed in order to proceed further. This is shown as an optional step 312. To make the dependency upon this optional step, if present, very robust, various techniques known in the art could be used. For example, any of the various data items required for step 315 (as described below) to succeed may be encrypted or missing, with decryption and/or downloading of those items provided only upon successful completion of rights acquisition step 312. Typically, this rights acquisition step may take the form of an automated World Wide Web interaction where the user is given various offers associated with a particular software application. The URL for such an interaction and/or associated security parameters, could be obtained from the secure hardware adjunct 12. There are many other ways that similar functionality could be attained.

At step 315, the integration framework software 14 selects the appropriate integration logic for the hardware environment of digital appliance 10, including the nature of the specific secure hardware adjunct 12 present. If the particular secure hardware adjunct 12 present supports uploading of software, then part of this integration logic may be uploaded as needed.

At step 320, the integration framework software 14 locates the sensitive functions 18 and the application neutral form 20. At step 325, the integration framework software 14 verifies the integrity of the sensitive functions 18 and of the application neutral form 20. This could be achieved in a number of ways, such as creating hash signatures and comparing the values with stored values. At step 330, the integration framework software 14 accesses the secure hardware adjunct 12 and substantially passes control to this device.

At step 335, the secure hardware adjunct 12 obtains the environmental data 22 that it needs to create the application executable form 24. Environmental data 22 could include characteristics of digital appliance 10, data input by the user, or data obtained from an Internet server. In the case of server-obtained data, the secure hardware adjunct 12 could be used to ensure that the server in question is a trusted entity with authentic data. For example, this could be achieved by using encrypted responses using an encryption key known only to the server where the corresponding decryption key is known only to the secure hardware adjunct 12. If the software and data at issue were obtained by download from a trusted server, that download could itself include such environment data so that a separate server interaction would not be required.

As has been described previously, environmental data 22 may be obtained directly by the secure hardware adjunct 12, and/or may be passed to the secure hardware adjunct 12 by a component of the integration framework software 14 running on processor 16. The methods chosen are largely dictated by the degree of visibility and control the secure hardware adjunct 12 has over the internals of the digital appliance 10.

At step 340, the secure hardware adjunct 12 reads the sensitive functions 18 and application neutral form 20 and performs the transformation (e.g. decryption) of application neutral form 20 and integration actions as determined by the integration framework software 14. The transformation could be done by using a private decryption key stored in secure hardware adjunct 12 to decrypt the application neutral form 20 to render it executable. If the application neutral form 20 had been rendered non-executable by the placement of “hooks” (see above), then the “fill” regions would be located and the nearby binary code altered in such a way as to make it executable. In one embodiment, this transformation would consist simply of replacing the “fill” regions with valid code implementing and/or invoking a particular sensitive function 18. This simultaneously accomplishes the objectives of restoring the code to valid executable status, and binding appropriate sensitive functions 18.

Typically, the transformation and integration processes will be done by reading and processing chunks of the sensitive functions 18 and the application neutral form 20 due to the limited processing and memory capabilities of the secure hardware adjunct 12. However, given a sufficiently capable secure hardware adjunct 12, more monolithic and secure approaches are possible. For example, rather than have the integration framework software 14 supply an explicitly chosen set of sensitive functions 18 (e.g. Digital Rights Management) to the secure hardware adjunct 12, it could instead upload a template containing a suite of potential functions, and leave it to the internal logic of the secure hardware adjunct 12 to determine which functions were incorporated and how.

The specific nature of the sensitive functions 18 is in no way limited by this invention. For example, if it were determined that the secure hardware adjunct 12 had sufficient performance to decrypt encrypted files in real-time, then a sensitive function to perform this decryption could be added, and a specific set of application data files would be encrypted to match.

For example, if the computer software application to be transformed in accordance with the present invention was a game with computer graphics, the application data files representing the computer graphics for each “level” of the game could be encrypted by the integration framework software 14 in such a way that they could only be decrypted, when accessed by the application executable form 24 at run-time, with the assistance of hardware adjunct 12. The encryption of the application data files could also have been performed prior to distributing the application neutral form 20, and if the distribution were on-line, the encryption of the application data files could be made unique to a particular user's instance of hardware adjunct 12. It is also possible that these application data files may have been distributed with one standard encryption key e.g. for mass distribution on CD-ROM media. In this case the files can be decrypted and then re-encrypted with a different key unique to a specific user's hardware adjunct 12.

At step 345, the secure hardware adjunct writes the application executable form to the memory or hard disk of the digital appliance. The integration process is completed at step 350, after which time the application executable form 24 can be executed on digital appliance 10.

The transformation and integration steps shown in FIG. 3 do not have to be followed only at time of first installation of a computer software application. If secure hardware adjunct 12 provides sufficient performance to complete the transformation and integration steps described above in an acceptably short period of time (e.g. less than five seconds), then those steps can be followed each time the computer software application is to be executed. In this way, only the application neutral form 20 is ever permanently stored on digital appliance 10, and the application executable form 24 may vary at the binary level between different executions on the same digital appliance 10.

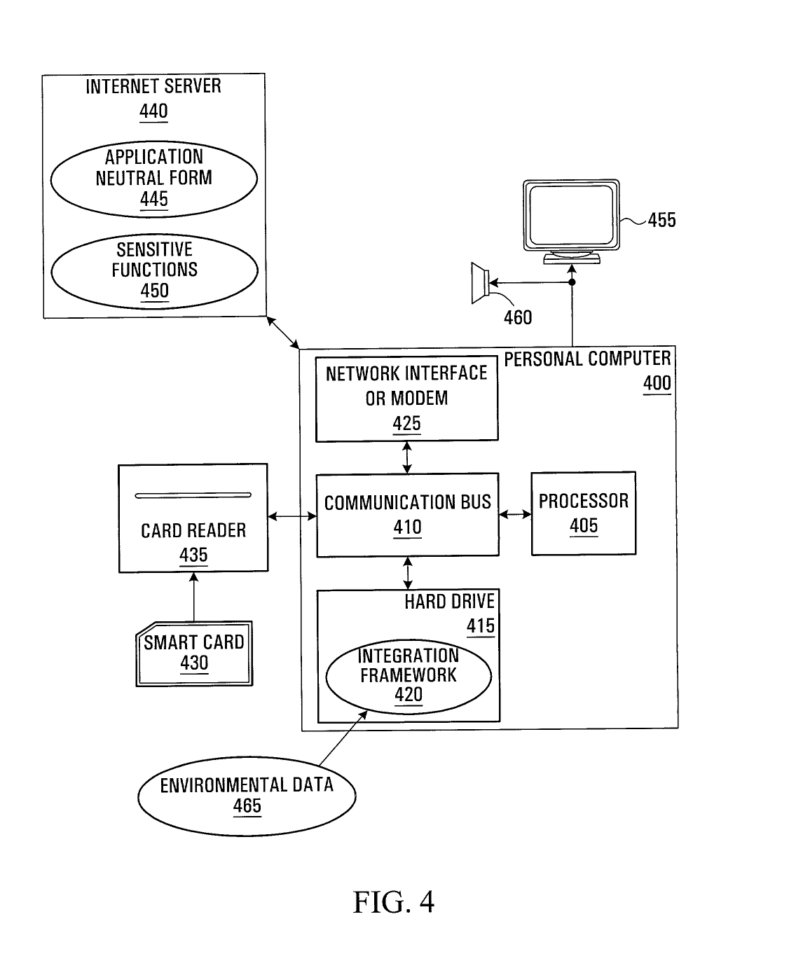

FIG. 4 is a schematic diagram of the first of two embodiments of the present invention to be described in detail. In this first embodiment, the digital appliance is a personal computer 400 (including processor 405, hard drive 415, display monitor 455 and speaker 460). The secure hardware adjunct takes the form of a smart card 430 and smart card reader 435.

Smart card 430 contains a processor and non-volatile memory. The non-volatile memory stores data such as cryptographic keys. A card reader 430 provides the interface between the smart card 430 and the personal computer 400. The card reader 435 is connected to a communication bus 410 of the personal computer 400 either directly, or through an external port, such as a serial port or a USB port, that allows it to exchange data with the personal computer 40. The card reader 435 contains a slot into which the smart card 430 is placed, and data is transferred between the smart card 430 and the card reader 435 using a low-speed serial interface standard to smart cards. Smart card 430 could also be “contactless”, e.g. powered by magnetic induction and communicating by short-range radio waves, with the same result.

An Internet server 440 hosts the sensitive functions 450 and the application neutral form 445 that are downloaded over the Internet to the personal computer 440 by means of the network interface or modem 425. Integration framework software 420 is stored on hard drive 415. Environmental data 465 is optionally used by integration framework software 420 and smart card 430.

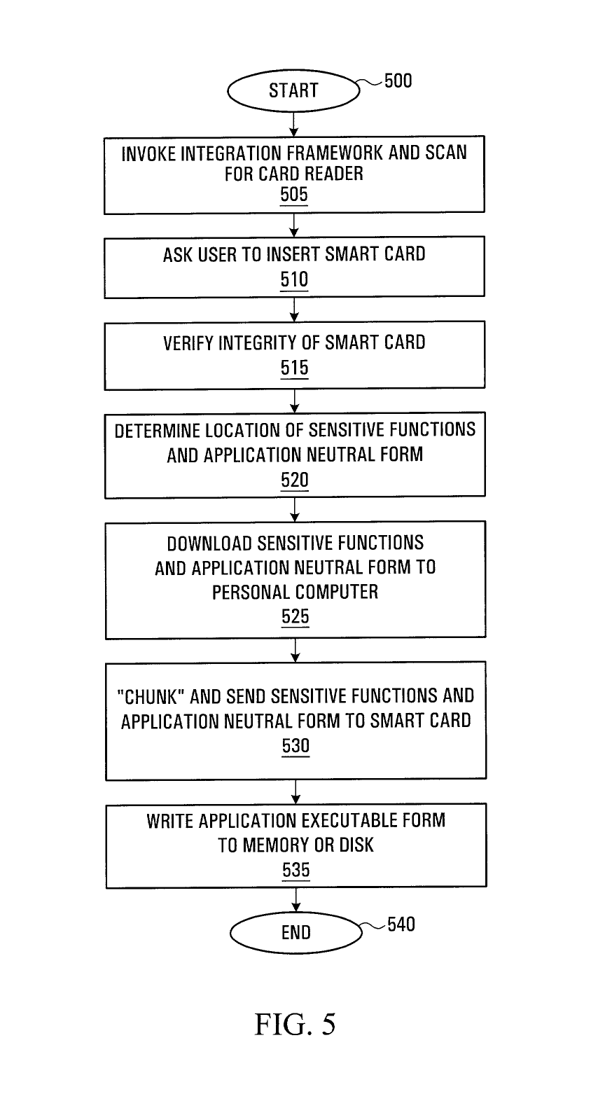

FIG. 5 is a flowchart for the embodiment shown in FIG. 4. Element numerals refer back to FIG. 4.

At step 505, the user invokes integration framework software 420 which then checks the ports of personal computer 400 for card reader 435. At step 510, integration framework software 420 displays a message asking the user to insert smart card 430 into card reader 435. At step 515, integration framework software 420 verifies the integrity of smart card 430. More specifically, by interacting with smart card 430, integration framework software 420 establishes, not only that it is a legitimate smart card with a known root of trust, but that it has appropriate programming (and optionally, appropriate stored rights and upload capability) to support the integration process and required hidden transformation for the computer software application to be processed.

At step 520, integration framework software 420 determines location of application neutral form 445 and sensitive functions 450. At step 525, the sensitive functions 450 and application neutral form 445 are downloaded from Internet server 440.

At step 530, the sensitive functions 450 and the application neutral form 445 are spilt into chunks and transferred, chunk-by-chunk, to smart card 430 for processing. Smart card 430 also receives environmental data 465 from the integration framework software 420 executing on processor 405, and transforms (e.g. decrypts) the application neutral form 445. The sensitive functions 450 are then bound to the application neutral form 445 by smart card 430, with the details of such binding mediated by factors including the environmental data 465.

At step 535, smart card 430 returns the application executable form to personal computer 400, where it is stored in random access memory or on hard disk 415. The application executable form can then be executed by personal computer 400.

Depending on the nature of sensitive functions 18, the application executable form may have continued dependency on the presence of smart card 430 in order to execute on processor 405. The integrated sensitive function 18 could set up appropriate monitoring threads to examine the environment for relevant changes (such as the removal of smart card 430 from card reader 435) throughout the execution of the program. If such changes were found, then either the user could be presented with a specific message on display device 455 and/or speaker 460 (e.g. “Please return smart card to reader”), or the application executable form could be automatically terminated and the system returned to step 505.

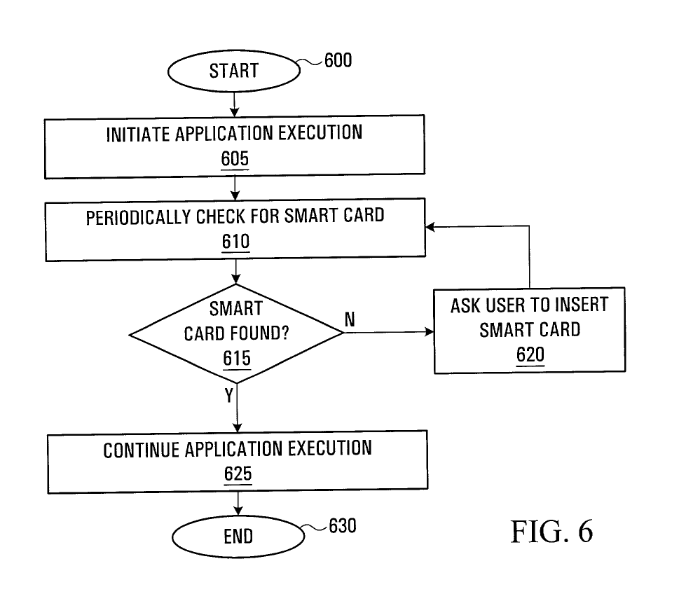

FIG. 6 is a flowchart of a possible run-time environment of the embodiment shown in FIG. 4 where the presence of smart card 430 is required for execution. At step 605, application executable form is executed by personal computer 400. At steps 610 and 615 (which is performed on a periodic basis), processor 405 checks for the presence of a compatible smart card 430. If compatible smart card 430 is not found, application executable form request that the user insert compatible smart card 430 for continued execution. If smart card 430 is found, application execution is continued until termination.

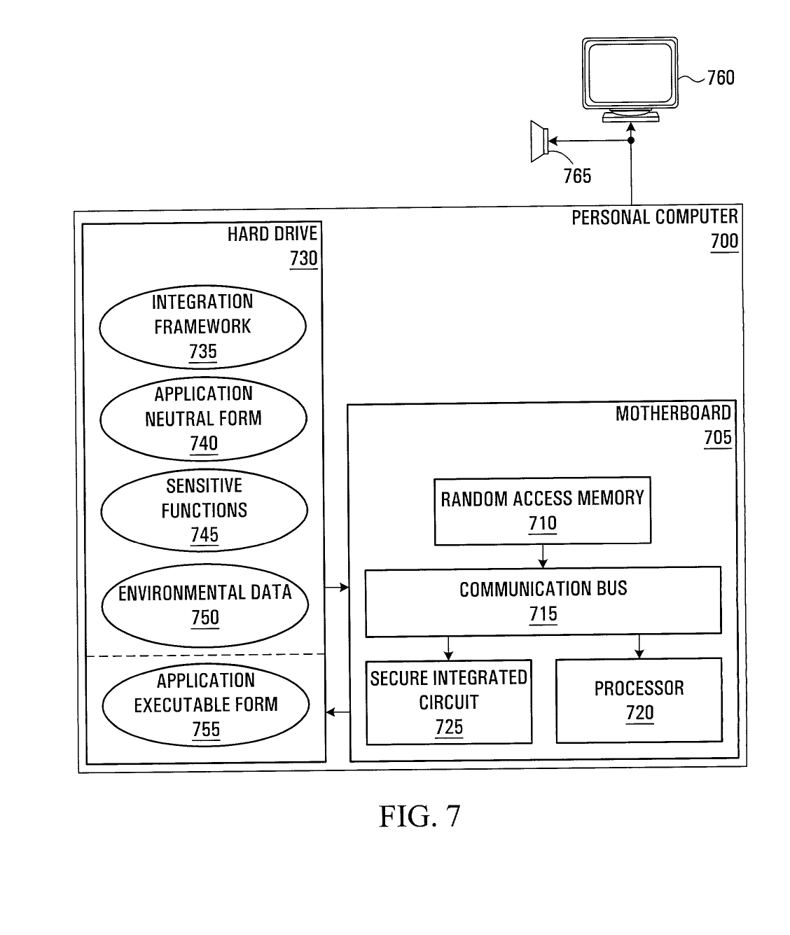

FIG. 7 is a schematic diagram of a second embodiment of the present invention. In this second embodiment, the digital appliance is a personal computer 700 (including motherboard 705, hard drive 730, display monitor 760 and speaker 765). Motherboard contains Random Access Memory 710 connected to communication bus 715. Processor 720 is also connected to communication bus 715. The secure hardware adjunct takes the form of secure integrated circuit 725 which is connected to communication bus 715.

Secure integrated circuit 725 is a closed hardware subsystem on motherboard 705 of personal computer 700. Secure integrated circuit 725 could be added to motherboard 705 at the time of manufacture of personal computer 700, or it could be added later as an optional peripheral chip. Secure integrated circuit 725 uses communication bus 715 to interface with the main personal computer processor 720, random access memory 710, hard drive 730, and optionally environmental data 750. Hard drive 730 contains integration framework software 735, application neutral form 740, and sensitive functions 745.

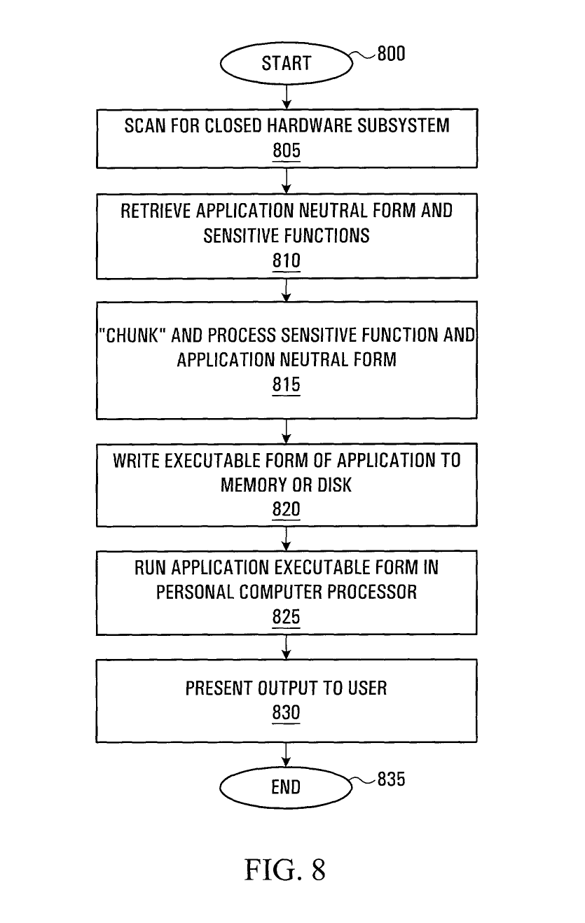

FIG. 8 is a flowchart for the embodiment shown in FIG. 7. Element numerals refer back to FIG. 7.

At step 805, when a user invokes integration framework software 735, the program checks the communication bus 715 of personal computer 700 for the presence of a closed hardware subsystem such as secure integrated circuit 725. At step 810, the sensitive functions 745 and the application neutral form 740 are retrieved from hard drive 730 by the integration framework software 735 using secure integrated circuit 725. In the case where secure integrated circuit 725 has “bus master” capability, it may retrieve this data from hard drive 730 directly. At step 815 the sensitive functions 745 and the application neutral form 740 are spilt into chunks and processed by secure integrated circuit 725. Secure integrated circuit 725 retrieves environmental data 750 from personal computer 700 and transforms (e.g. decrypts) the application neutral form 740. The sensitive functions 745 and applicable environmental data 750 are then bound to the application neutral form 740 by secure integrated circuit 725.

At step 820, the application executable form 755 is returned by secure integrated circuit 725 to personal computer 700 where it is stored in random access memory 710 or on hard disk 730. The application executable form then runs on personal computer 700 and presents its output to the user on display monitor 760 and/or speaker 765.

The above description of a preferred embodiment should not be interpreted in any limiting manner since variations and refinements can be made without departing from the spirit of the invention. The scope of the invention is defined by the appended claims and their equivalents.

We claim:

1. A method of producing an executable instance of a software application in a secure hardware adjunct where secure processing is performed, the method comprising the steps of:
providing a non-executable form of a software application to the secure hardware adjunct,
providing sensitive functions to the secure hardware adjunct,
transforming the non-executable form of the software application into an executable form of the software application in the secure hardware adjunct;
integrating the sensitive functions with the executable form of the software application in the secure hardware adjunct to produce an executable instance of the software application; and
outputting the executable instance of the software application to a digital appliance.

2. The method of claim 1 wherein the sensitive functions comprise one or more of the following:
i. a digital rights management algorithm;
ii. a user authentication algorithm;
iii. a user contract determination algorithm;
iv. a cryptographic key request and download algorithm; and
v. an algorithm for scanning the digital appliance for appliance-specific identifiers.

3. The method of claim 1 further including the steps of:
locating the non-executable form of the software application and the sensitive functions on an Internet server; and downloading the non-executable form of the software application and the sensitive functions from the Internet server.

4. The method of claim 1 wherein the secure hardware adjunct is implemented by one of the following:
i. a secure integrated circuit on a motherboard of the digital appliance;
ii. a secure integrated circuit on an expansion board of the digital appliance;
iii. an external device connected to the digital appliance through an external port;
iv. a smart card and smart card reader; or
v. a component of a wireless Internet-enabled handheld device.

5. The method of claim 1 further including the step of:
following the transforming step, varying the positioning of binary instructions of the executable form of the software application in the secure hardware adjunct.

6. The method of claim 1 wherein the step of transforming includes the step of using a private decryption key stored in the secure hardware adjunct to decrypt the non-executable form of the software application.

7. The method of claim 1 further including the step of executing the executable instance of the software application in the digital appliance immediately upon completion of the outputting step.

8. The method of claim 1 further including the steps of:
inspecting the digital appliance for environmental data;
providing the environmental data to the secure hardware adjunct.

9. The method of claim 8 further including the step of:
embedding the environmental data in the executable instance of the software application, the environmental data functioning upon execution of the software application to restrict execution to the digital appliance.

10. The method of claim 8 further including the steps of:
prior to the integrating step, using the environmental data to select, from among the provided sensitive functions, a subset of sensitive functions to be integrated into the executable form of the software application.

11. The method of claim 8 further including the steps of:
following the outputting step, re-inspecting the digital appliance for environmental data;
executing the executable instance of the software application only if the environmental data provided to the secure hardware adjunct matches the environmental data located during the re-inspecting step.

12. The method of claim 8 wherein the environmental data consists of information about one or more of the following:
i. the digital appliance executing the executable instance of the software application;
ii. a user;
iii. the secure hardware adjunct; and
iv. network accessible resources.

13. The method of claim 1 further including the steps of:
locating environmental data on an Internet server;
authenticating the environmental data;
encrypting the environmental data;
downloading the environmental data from the Internet server to the secure hardware adjunct; and
decrypting the environmental data in the secure hardware adjunct.

14. The method of claim 8 wherein the secure hardware adjunct is a bus master, capable of inspecting the digital appliance independent of any hardware or software contained in the digital appliance.

15. The method of claim 8 wherein the inspecting and providing steps are performed under the control of an auxiliary external software program.

16. The method of claim 1 further including the step of inspecting the secure hardware adjunct for environmental data.

17. The method of claim 1 wherein the step of providing a non-executable form of a software application to the secure hardware adjunct includes the following steps:
embedding a private decryption key in the secure hardware adjunct;
encrypting the software application with a public encryption key corresponding to the private decryption key to produce a non-executable form of the software application;
downloading the non-executable form of the software application from an Internet server to the secure hardware adjunct.

18. The method of claim 1 further including the steps of:
executing the executable instance of the software application in the digital appliance;
verifying the status of the secure hardware adjunct;
if the status of the secure hardware adjunct is changed, then ceasing the execution of the executable instance of the software application.

19. The method of claim 18 further including the step of:
passing control over the executable instance of the software application to an integration framework software process, so that said process might provide recovery action beyond simply stopping the application.

20. The method of claim 1 further including the steps of:
scanning the digital appliance for identification data;
providing the identification data to the secure hardware adjunct;
integrating the identification data with the executable form of the software application;
and wherein the outputted executable instance of the software application further incorporates the identification data.

21. The method of claim 1 wherein the step of integrating includes the following:
selecting, from among the provided sensitive functions, a subset of sensitive functions to be integrated into the executable form of the software application.

22. The method of claim 1 wherein the non-executable form of the software application cannot be rendered executable without the integration of the sensitive functions.

23. The method of claim 1 further including the steps of:
requesting the entry of a personal identification number; and
executing the executable instance of the software application only if the entered personal identification number matches a personal identification number integrated into the executable instance of the software application.

24. The method of claim 1 further including the steps of:
providing encrypted data files associated with the non-executable form of the software application to the secure hardware adjunct;
decrypting the encrypted data files in the secure hardware adjunct.

25. The method of claim 1 further including the step of:
authorizing the rights of a user to access the executable instance of the software application and only proceeding to the transforming, binding and outputting steps if the user's rights have been authorized.

26. The method of claim 26 wherein the step of authorizing includes the steps of:
embedding the secure hardware adjunct with a reserve of electronic cash;
initiating an interaction with a banking server; and
deducting a payment from the reserve of electronic cash.

27. A secure hardware adjunct comprising:
a processor where secure processing can be performed, read only memory connected to said processor;
random access memory connected to said processor;
input and output paths for communication between the processor and a digital appliance;
a secure housing covering the processor, the read only memory and the random access memory, the secure housing being resistant to tampering and observation of data and algorithms in the processor, the read only memory and the random access memory;
the processor, upon being provided with a non-executable form of a software application and sensitive functions on the input path, transforms the non-executable form of the software application into an executable form of the software application; integrates the sensitive functions with the executable form of the software application to produce an executable instance of the software application; and outputs on the output path the executable instance of the software application to the digital appliance.

28. The secure hardware adjunct of claim 27 wherein said processor is connected to a smart card reader.

29. The secure hardware adjunct of claim 27 wherein said processor comprises part of an integrated circuit on an expansion board of the digital appliance.

30. The secure hardware adjunct of claim 27 wherein the sensitive functions comprise one or more of the following:
i. a digital rights management algorithm;
ii. a user authentication algorithm;
iii. a user contract determination algorithm;
iv. a cryptographic key request and download algorithm; and
V. an algorithm for scanning the digital appliance for appliance-specific identifiers.

31. Computer readable medium storing processor executable instructions for use in producing an executable instance of a software application in a secure hardware adjunct where secure processing is performed, the secure hardware adjunct being provided with a non-executable form of a software application and sensitive functions, the processor executable instructions when loaded at a processor in the secure hardware adjunct adapt said processor to:
transform the non-executable form of the software application into an executable form of the software application;
integrate the sensitive functions with the executable form of the software application to produce an executable instance of the software application; and
output the executable instance of the software application to the digital appliance.

32. The computer readable medium of claim 31 wherein the secure hardware adjunct is implemented by one of the following:
i. a secure integrated circuit on a motherboard of the digital appliance;
ii. a secure integrated circuit on an expansion board of the digital appliance;
iii. an external device connected to the digital appliance through an external port;
iv. a smart card and smart card reader; or
V. a component of a wireless Internet-enabled handheld device.

33. The computer readable medium of claim 31 wherein the sensitive functions comprise one or more of the following:
i. a digital rights management algorithm;
ii. a user authentication algorithm;
iii. a user contract determination algorithm;
iv. a cryptographic key request and download algorithm; and
v. an algorithm for scanning the digital appliance for appliance-specific identifiers.
